(19) United States
(12) Patent Application Publication
(10) Pub. No.: US 2006/0006307 A1
(43) Pub. Date: Jan. 12, 2006

(54) System and method for attenuating mechanical vibrations

(76) Inventor: Marlen Mogilever, Thornhill (CA)

Correspondence Address: BERESKIN AND PARR, 40 KING STREET WEST, BOX 401, TORONTO, ON, M5H 3Y2, CA

(21) Appl. No.: 11/175,285

(22) Filed: Jul. 7, 2005

Related U.S. Application Data
(60) Provisional application No. 60/585,573, filed on Jul. 7, 2004.

(51) Int. Cl. F16M 1/00; F16M 7/00

(52) U.S. Cl. 248/638

(57) ABSTRACT

The system includes a base for resting on a surface, such as a floor, and a platform for resting the device thereon. Compressible spokes connect the platform to the base. Mechanical vibrations of the device are attenuated by the base, platform and spokes when the device is resting on the platform. The spokes are composed of a dampening material such as polyurethane.

### PRIOR APPLICATION

This application claims the benefit of U.S. Provisional Application Ser. No. 60/585,573, filed Jul. 7, 2004 entitled “SYSTEM AND METHOD FOR ATTENUATING MECHANICAL VIBRATIONS”.

### FIELD OF THE INVENTION

This invention relates to systems for attenuating mechanical vibrations.

### BACKGROUND OF THE INVENTION

Many types of devices produce or affected by unwanted mechanical vibrations. For example, audio/video equipment can vibrate when sound is produced. These vibrations distort the acoustical output, resulting in inferior sound reproduction. These vibrations may also transmit to the floor supporting the device. In a situation where tenants are nearby, the unwanted noise is a nuisance. This is particularly the case in apartment buildings when audio/video equipment is operated at times likely to inconvenience other tenants.

Unwanted vibrations can arise in a device from a number of sources. The preeminent source is the device itself. Loudspeakers cause components coupled thereto, such as speaker cabinets, to vibrate. Also, the sound produced by loudspeakers when incident on other components of an audio/video system cause these components to vibrate. Other sources of vibration are external to the audio/video system and arise from other electrical devices, such as appliances like refrigerators, furnaces and air conditioners. Likewise, vehicular traffic (e.g., automobiles, trains, airplanes) can cause unwanted vibrations. All these sources of external vibrations can rattle audio/video equipment producing deleterious effects in sound reproduction. These unwanted vibrations are often at resonant frequencies that can lead to large amplitude vibrations.

Unwanted vibrations can distort sound in a number of ways. Low-level detail may be blurred or concealed. Bass, which is typically difficult to reproduce, is compromised. Fidelity and musicality can be adulterated. Oftentimes, manufacturers spend a lot of time an energy producing equipment that has superior musical output without giving much thought to how unwanted vibrations can reduce the quality of the sound experience. It is not uncommon for high-end equipment to cost tens of thousands of dollars without being able to perform to its potential because of extraneous mechanical vibrations.

While audio/video equipment has been emphasized above, there are many other types of devices where unwanted mechanical vibrations are a problem. A few of these include, operating theaters, where vibrations can have serious consequences when performing microsurgery, and laser systems where the precise application of a laser to a particular area is of paramount importance.

Therefore, a system that can reduce or eliminate unwanted mechanical vibrations by effectively dampening these vibrations would be most welcome.

### SUMMARY OF THE INVENTION

Described herein is a system for reducing mechanical vibrations in a device. The system includes a base for resting on a surface, such as a floor, and a platform for resting the device thereon. Compressible spokes connect the platform to the base. Mechanical vibrations of the device are attenuated by the base, platform and spokes when the device is resting on the platform. The spokes are composed of a dampening material such as polyurethane.

### DETAILED DESCRIPTION OF THE INVENTION

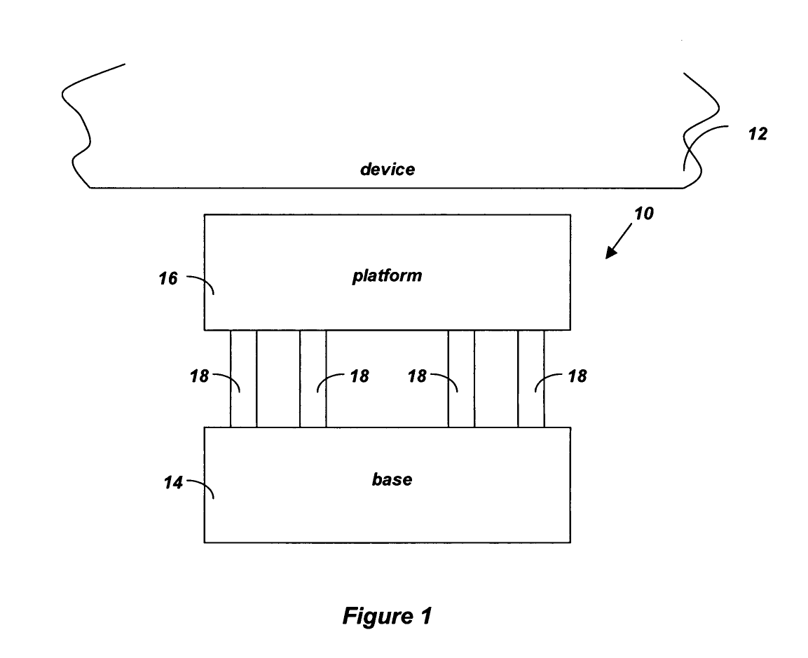

FIG. 1 shows a block diagram of an attenuating system 10 for attenuating mechanical vibrations in a device 12. In a typical application, the device 12 includes audio/video equipment, such as CD players, DVD players, pre-amplifiers and amplifiers. By reducing vibrations, the system 10 helps improve the sound quality and fidelity of the audio/video equipment. In another application, the device can be an operating table at a hospital.

The system 10 includes a base 14, a platform 16 and compressible spokes 18 connecting the platform 16 to the base 14.

The base 14 rests on a surface, such as a floor, desk or cabinet. The device 12 rests on the platform 16. Compressible spokes 18 connect the platform 16 to the base 14. Mechanical vibrations of the device 12 are attenuated as vibrational energy travels from the device 12, to the platform 16, to the spokes 18 and then finally to the base 14. Most of the vibrational energy is absorbed before reaching the base 14. Consequently, the surface on which the base 14 rests, such as a floor, does not vibrate, which is particularly helpful where such vibrations would inconvenience others, such as would be the case in a high-rise apartment building.

The system 10 also finds use in many other areas where a reduction of mechanical vibrations is desired, such as in operating theaters, where the elimination of vibrations are important for surgery, especially microsurgery, and in research environments where precise measurements require the diminution of unwanted vibrations.

The compressible spokes 18 may be composed of self-skinned polyurethane molded foam. In such case, the whole system 10 may be conveniently composed of polyurethane using a single mold. Other cured or porous materials may also be used.

To support a device 12, any number of systems 10 can be used. Typically, four systems 10 can be placed at the corners of a box-shaped device 12. However, more or less than four systems 10 may be placed under the device 12, as appropriate.

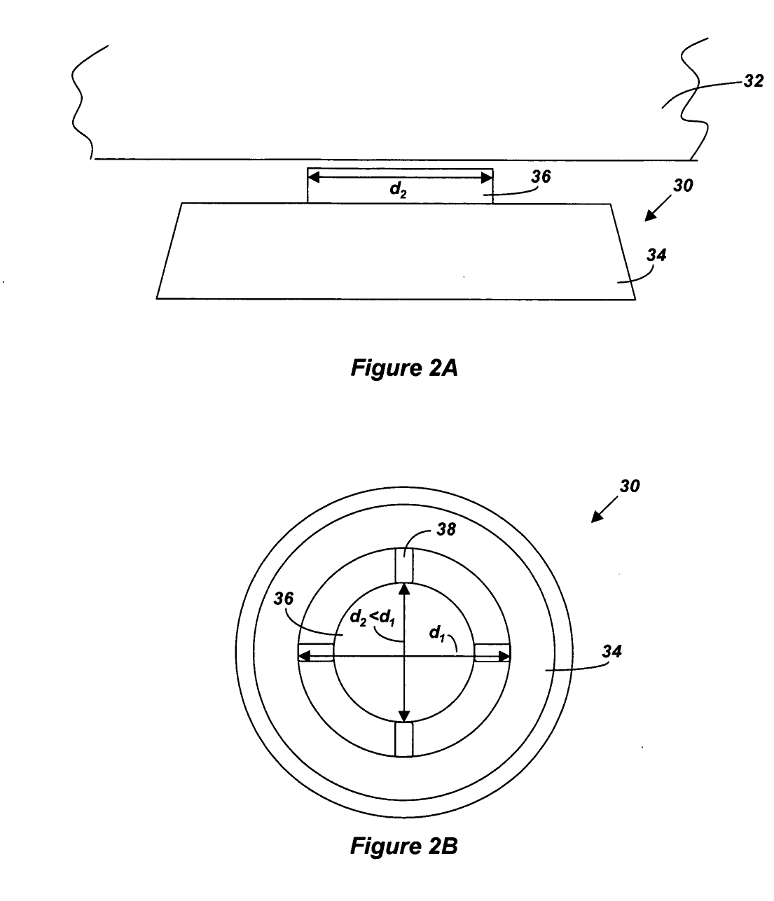

FIGS. 2A and 2B show in side and plan views, respectively, an attenuating system 30 for attenuating mechanical vibrations in a device 32, such as audio/video equipment, consistent with the principles of the present invention. The system 30 includes a ring-shaped base 34 of diameter d₁, and a disk-shaped platform 36 of diameter d₂<d₁, the platform 36 being co-axial with the base 34 and disposed above the base 34. Compressible spokes 38 connect the platform 36 to the base 34.

The ring-shaped base 34 rests on a surface, such as a floor, desk or cabinet. The device 32 rests on the disk-shaped platform 36. The compressible nature of the spokes 38 help to reduce mechanical vibrations of the device 32, as vibrational energy travels from the disk-shaped platform 36 to the ring-shaped base 34 via the spokes 38.

The compressible spokes 38 may be composed of self-skinned polyurethane molded foam. In such case, the whole system 30 may be conveniently composed of polyurethane using a single mold. If desired, the external polyurethane surface of the system 30 may be painted. Various colours that would be attractive alongside the audio/video equipment can be used.

The number of compressible spokes 38 is usually three or more. The precise number can depend on the weight of the device 32. In particular, as the weight increases, a system 30 with more spokes 38 can be used to prevent the platform 36 from otherwise collapsing. In addition, the density of the polyurethane comprising the components of the system 30 can vary according to the weight of the device 32, the lower the density of the polyurethane the smaller the weight of the device 32.

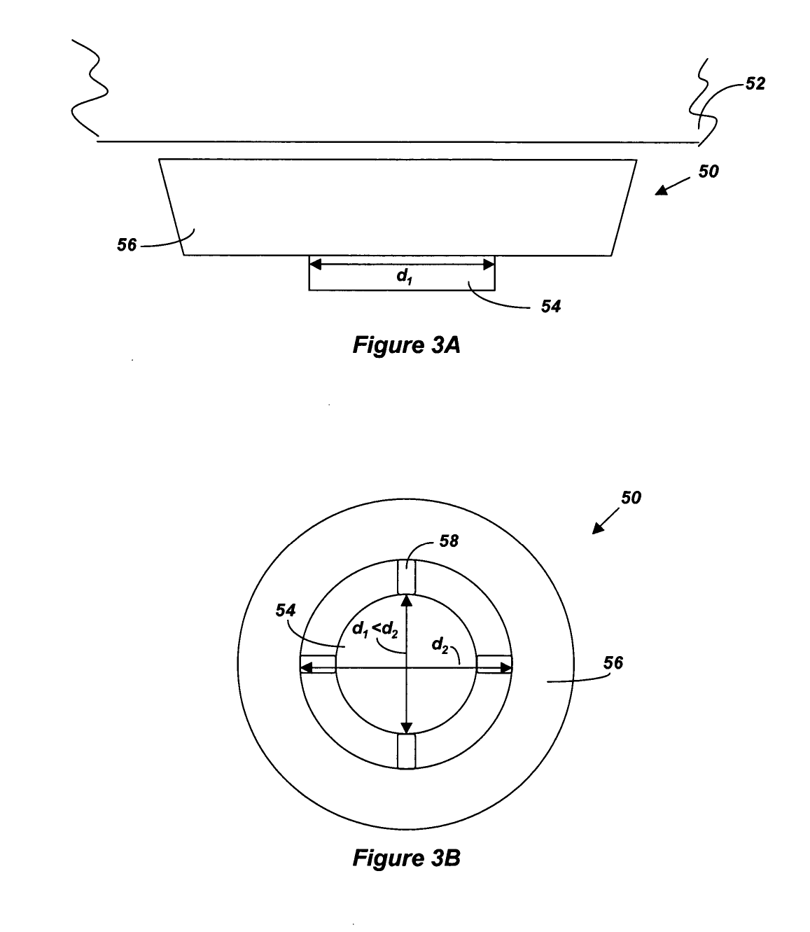

FIGS. 3A and 3B show in side and plan views, respectively, an attenuating system 50 for attenuating mechanical vibrations of a device 52. The system 50 includes a disk-shaped base 54 of diameter d₁, and a ring-shaped platform 56 of diameter d₂>d₁, the platform 56 being co-axial with the base 54 and disposed above the base 54. Compressible spokes 58 connect the platform 56 to the base 54.

As will immediately be recognized, system 50 is the same as system 30 but inverted so that the device 52 rests on the wider ring-shaped platform 56 instead of the narrower disk shaped base 54. The disk-shaped base 54 rests on a surface, such as a floor, desk or cabinet. The compressible nature of the spokes 58 help to reduce mechanical vibrations of the device 52, as vibrational energy travels from the ring-shaped platform 56 to the disk-shaped base via the spokes 58. As described above, the system 50 may be composed of polyurethane and derived from a single mold.

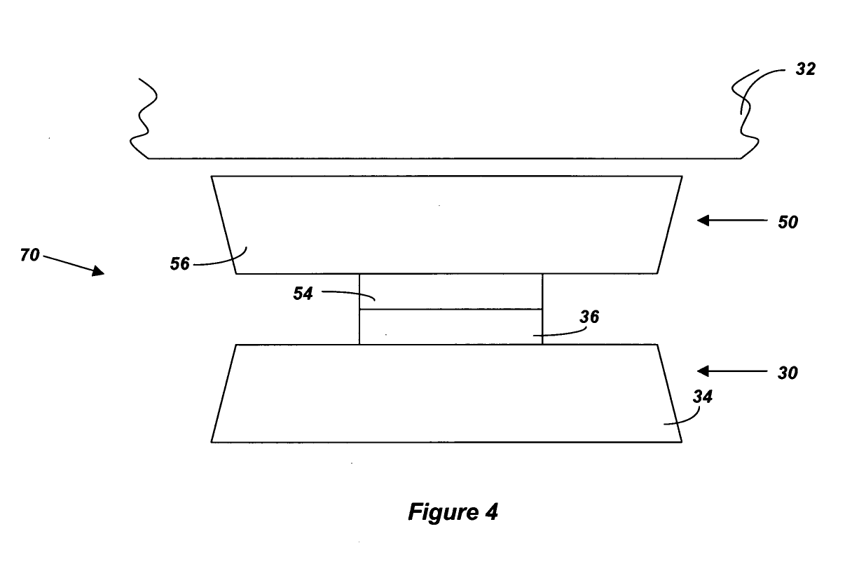

FIG. 4 shows a stack system 70 comprised of the systems 30 and 50 of FIGS. 2 and 3. Such a stack system 70 is formed by stacking systems 30 and 50 so that the disk-shaped platform 36 abuts the disk-shaped base 54. The ring-shaped base 34 rests on a surface, such as a floor, and the device 52 rests on the ring-shaped platform 56. The stack system 70 can be used to attenuate particularly large mechanical vibrations, where system 30 or system 50 alone might not be adequate. Another application of the stack formation arises when the height of device 32 resting thereon needs to be raised. It should be appreciated that a plurality of pairs of systems 30 and 50 may be stacked to form a stack system 70 that is arbitrarily tall.

FIG. 4 shows the system 50 of FIG. 3 stacked on top of the system 30 of FIG. 2. It should be understood that in another embodiment, system 30 may be stacked on top of system 50. In such case, the disc-shaped base rests on a surface, such as a floor or cabinet surface, while the device 32 rests on the disc-shaped platform 36.

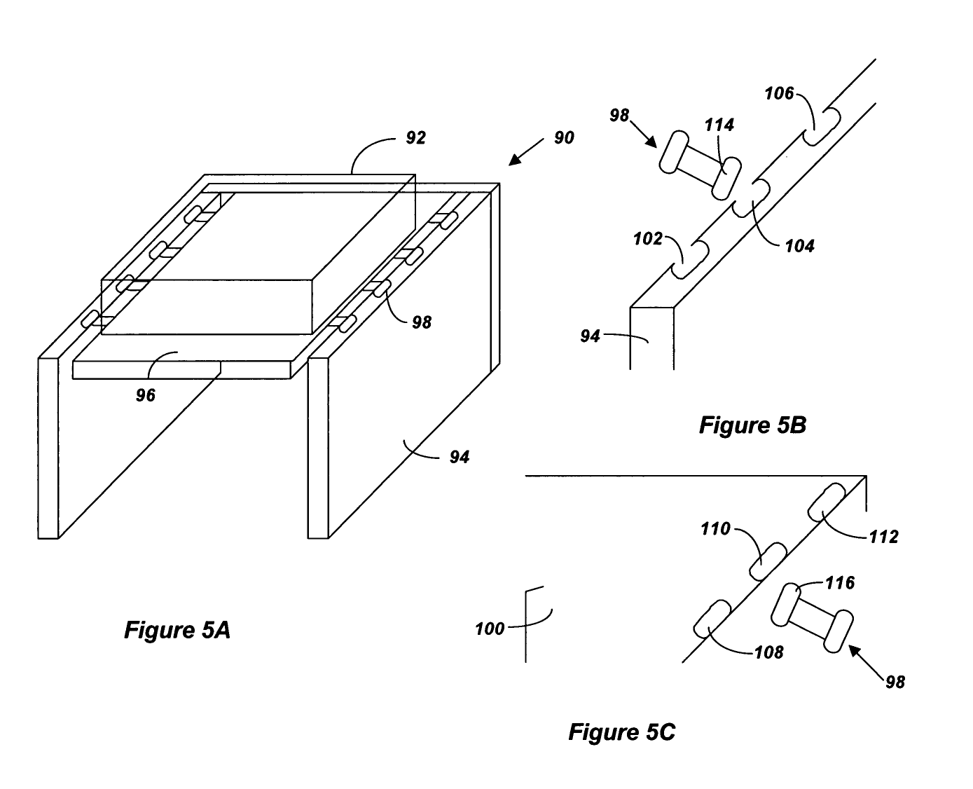

FIG. 5A shows an attenuating system 90 exemplifying another embodiment for attenuating mechanical vibrations of a device 92. The system 90 includes a three-walled, box-shaped base 94, a rectangular-shaped platform 96 and compressible spokes 98 connecting the platform 96 to the base 94. The spokes 98 are individually removably attached to the platform 96 and to the base 94.

The base 94 rests on a surface, such as a floor, desk or cabinet. The device 92 rests on the platform 96. Compressible spokes 98 connect the platform 96 to the base 94. Mechanical vibrations of the device 92 are attenuated as vibrational energy travels from the device 92, to the platform 96, to the spokes 98 and then finally to the base 94, with most of the vibrational energy being absorbed before reaching the base 94.

FIG. 5B shows an exploded view of a portion of FIG. 5A with the platform 96 omitted, and FIG. 5C shows an exploded view of the underside 100 of the platform 96 of FIG. 5A with the base 94 omitted. In FIG. 5B, three base female receptors 102, 104 and 106 are shown on the base 94. In FIG. 5C, three complementary platform female receptors 108, 110 and 112 are shown on the underside 100 of the platform 96.

Each of the female receptors 102, 104 and 106 can receive a single compressible spoke 98. One compressible spoke 98 is shown, one portion 114 of which is manually inserted into the base female receptor 104. An opposite portion 116 is inserted into the complementary platform female receptor 110 on the underside 100 of the platform 96.

Although FIGS. 5B and 5B each only display three female receptors 102, 104 and 106, and 108, 110 and 112, it should be understood that more receptors are present around the periphery of both the base 94 and platform 96. For a particular application, however, not all receptors need contain a spoke 98. The number of spokes 98 present in the system 90 depends on the amplitude of the mechanical vibrations that are to be attenuated and on the weight of the device, the greater the amplitude or weight, the larger the number of spokes 98 that can be used. By adding enough spokes 98, collapse of the platform 96 due a heavy device 92 resting thereon is avoided. The spokes 98 are individually removable by hand and fit into the female receptors 102, 104 and 106, and 108, 110 and 112. Because the spokes 98 are compressible, they may be made to fit snugly, perhaps by having to squeeze the spokes 98 before insertion into the receptors. Each spoke 98 is bone-shaped with two “knobs” on either side. The knobs prevent the spokes from sliding out of the receptors 102, 104 and 106, and 108, 110 and 112 under the weight of the device 92. That is, although the spokes 98 are designed to stretch when a device 92 is placed on the platform, the knobs do not stretch to the point where the spoke 98 can slip out of the receptor. It should be understood that the density and the size of the spokes 98 (and the size of the corresponding receptors) may vary. For example, a heavier device load might require the use of denser or larger receptors.

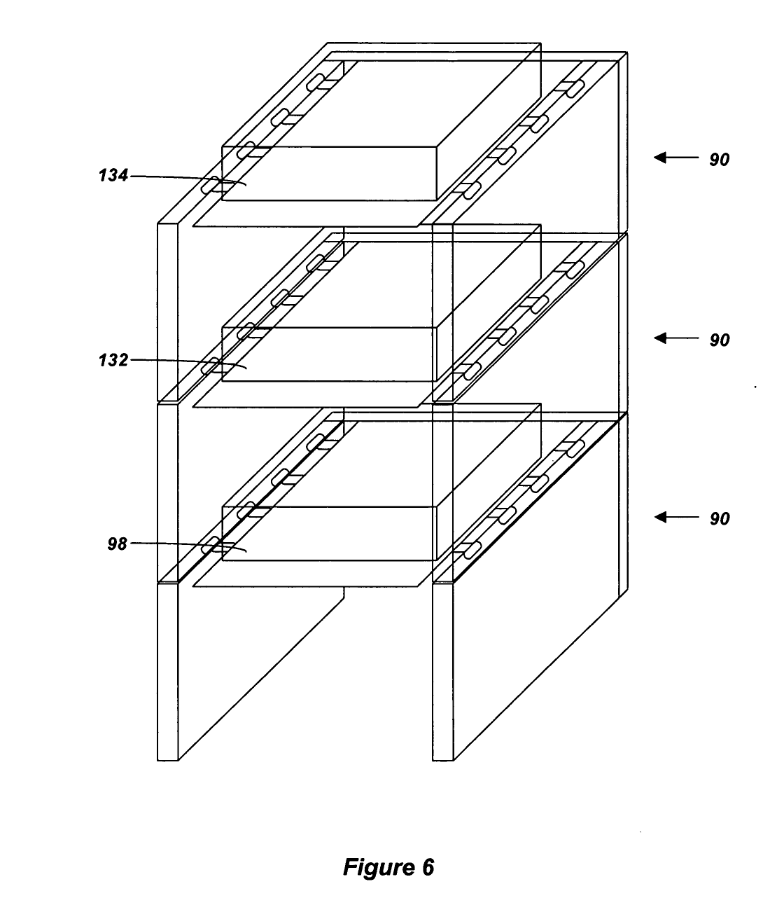

The embodiment that is the system 90 of FIG. 5 may be modified in a number of ways. First, the rear vertical wall of the base 94 and the rear edge of the platform 96 may also include receptors. By inserting spokes 98 therein, the base 94 and the platform 96 may be further connected at the rear. In addition, the base 94 may be constructed to include a front fourth wall, whose height may be different than the heights of the other three walls of the base 94. For example, the front fourth wall may be shorter than the other three walls with the top of the front wall substantially flush with the platform 96. Making the front fourth wall shorter in this manner allows devices to be easily inserted into a stack arrangement of systems 90 (see FIG. 6, described below).

It should also be understood that the “linear density” of spokes 98 (i.e., the number of spokes per unit length) and/or receptors need not be uniform along the various walls of the base 94. If the system 90 is designed for a device that has a non-uniform weight distribution, then more receptors and spokes can be added to whichever side bears the greater amount of weight of the device.

The base 94 and platform 96 can be composed of any one of number of materials including wood, plywood, Masonite™, acrylic and medium density fiberboard (MDF). The spokes 98 can be composed of any compressible material, such as polyurethane.

FIG. 6 shows a system 130 for attenuating mechanical vibrations that is comprised of a plurality of the attenuating systems 90 stacked one on top of each other. The back wall of the base 94 can have a gap at the bottom to allow electrical wires from the device 92 to exit the back. The system can accommodate several devices 92, 132 and 134. For example, the devices 92, 132 and 134 can be components of an audio/video system, such as a CD player, amplifier and DVD player.

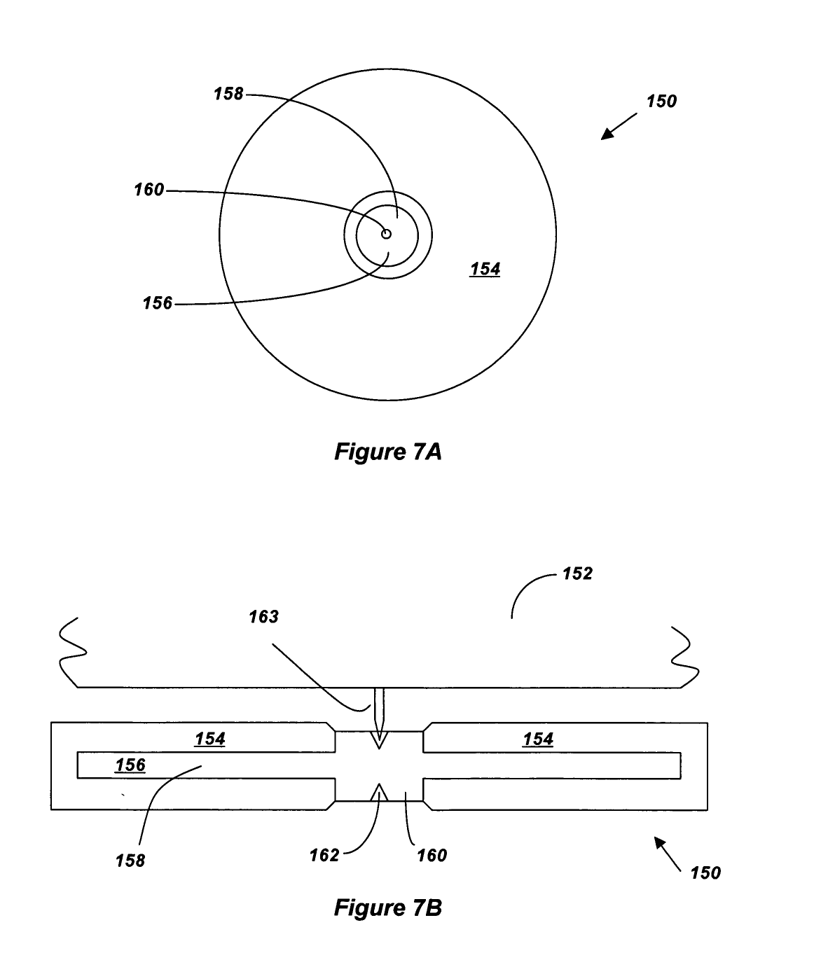

FIGS. 7A and 7B show a plan view and cross section of a system 150 for attenuating mechanical vibrations of a device 152, especially designed for devices such as speaker systems but which may also be used for other devices that produce unwanted vibrations. The system 150 includes a compressible component 154 and a dense component 156. The compressible component 154 can be composed of polyurethane, for example. The dense component 156 has a covered portion 158 and an uncovered portion 160. The covered portion 158 is covered and in contact with the compressible component 154.

The dense component 156 need not be monolithic, but can instead be made from a number of subparts. In one embodiment, for example, a center core of the dense component 156 may be hollow. Later in the manufacturing process, a complementary piece of dense component can be removably or, preferably, permanently inserted into the hollow center core.

The device 152 rests on a part of the uncovered portion 160, vibrational energy from the device 152 being attenuated by the compressible component 154.

In the embodiment of the system 150 shown in FIG. 7, the system 150 is disk-shaped. The disk has an external surface the largest fraction of which is composed of the compressible component 154. A smaller fraction of the external surface, near the center of the disk on either side thereof, is composed of the dense component 156. At the center of the disk, on either side, is a notch 162 that can be used with speaker systems, and other audio/video equipment, having spikes 163 at the base. Each spike 163 of the speaker system can be inserted into a notch 162.

Because the dense component 156 is designed to sustain the pressure below the notch 162 due to the weight of the device 152, it is desirable that the dense component 156 be composed of a dense material, such as acrylic, nylon, plastic, polyvinylchloride or any other material that can be injected and which dries to form a dense solid.

A component of an audio/video system typically contains four spikes 163 at the base, and under each such spike 163, a system 150 can be placed to attenuate vibrations.

Vibrational energy is received from the device 152 by the dense component 156. In turn, the dense component 156 transmits the vibrational energy to the compressible component 154, where the vibrations are dampened.

In other applications, the system 150 can be used for devices having no spikes. For example, spikeless speakers can rest directly on the compressible component 154. Likewise, the legs of an operating table can rest directly on the compressible component to reduce vibrations of the table during an operation.

It should be understood that various modifications could be made to the embodiments described and illustrated herein, without departing from the present invention. For example, although emphasis has been placed on a system for attenuating mechanical vibrations in audio/video equipment, the present system and method can be also applied to other devices where unwanted vibrations exist, such as medical equipment, and manufacturing equipment. The scope of the invention is defined in the appended claims.

What is claimed is:

1. A system for reducing mechanical vibrations in a device, the system comprising
a base for resting on a surface;
a platform for resting the device thereon;
compressible spokes connecting the platform to the base, wherein mechanical vibrations of the device are attenuated by the base, platform and spokes when the device is resting on the platform.

2. The system of claim 1, wherein the mechanical vibrations arise from at least one of an internal source that is internal to the device and an external source that is external to the device.

3. The system of claim 1, wherein the device is audio/video equipment.

4. The system of claim 1, wherein the base is ring-shaped of diameter d₁.

5. The system of claim 4, wherein the platform is disk-shaped of diameter d₂<d₁, the platform being co-axial with the base and disposed above the base.

6. The system of claim 5, wherein the number of compressible spokes is three, four or five.

7. The system of claim 3, wherein the base is disk-shaped of diameter d₁.

8. The system of claim 7, wherein the platform is ring-shaped of diameter d₂>d₁, the platform being co-axial with the base and disposed above the base.

9. The system of claim 8, wherein the number of compressible spokes is three, four or five.

10. The system of claim 1, wherein the compressible spokes are individually removably connected to both the base and the platform so that more spokes can be added so as to prevent the platform from collapsing if the weight of the device is large.

11. The system of claim 1, wherein the compressible spokes are composed of a porous material.

12. The system of claim 11, wherein the porous material is polyurethane.

13. The system of claim 11, wherein the base and platform are composed of the same porous material.

14. The system of claim 1, wherein the compressible spokes are composed of a cured material.

15. The system of claim 14, wherein the cured material is polyurethane.

16. The system of claim 14, wherein the base and platform are composed of the same cured material.

17. A system for reducing mechanical vibrations in a device, the system comprising
a compressible component; and
a dense component having a covered portion, which is covered and in contact with the compressible component, and an uncovered portion, wherein the device rests on a part of the uncovered portion, vibrational energy from the device being attenuated by the compressible component.

18. The system of claim 17, wherein the device includes a speaker system.

19. The system of claim 17, wherein the system is disk-shaped, the disk having an external surface the largest fraction of which is composed of the compressible component, and a smaller fraction of which, near the center of the disk on either side thereof, is composed of the dense component.

20. The system of claim 17, wherein the compressible component is polyurethane.

21. The system of claim 17, wherein the dense component is composed of acrylic, nylon, plastic or polyvinylchloride (PVC).

22. A system for reducing mechanical vibrations in a device, the system comprising
a compressible component; and
a dense component having a covered portion, which is covered and in contact with the compressible component, and an uncovered portion, wherein the device rests on a part of the compressible component, vibrational energy from the device being attenuated by the compressible component.
